(19) United States
(12) Patent Application Publication
(10) Pub. No.: US 2026/0027496 A1
(43) Pub. Date: Jan. 29, 2026

(54) WATER FILTRATION ASSEMBLY

(71) Applicant: CULLIGAN INTERNATIONAL COMPANY, Rosemont, IL (US)

(72) Inventors: Stephen WIGGINS, Morton Grove, IL (US); Chia H. KUNG, Libertyville, IL (US); Tedd M. SCHNEIDEWEND, Glen Ellyn, IL (US); Adam SLOMA, Arlington Heights, IL (US)

(21) Appl. No.: 18/785,245

(22) Filed: Jul. 26, 2024

(51) Int. Cl. B01D 29/11; B01D 35/30

(52) U.S. Cl. CPC B01D 29/114; B01D 35/30; B01D 2201/167; B01D 2201/291; B01D 2201/303; B01D 2201/4007; B01D 2201/4053; B01D 2201/4084; B01D 2201/4092

(57) ABSTRACT

A filter cartridge housed within a filter sump which mates with a filter head that is in fluid communication with an existing water line, where the filter cartridge includes a filter element having a bottom end and a top end, a bottom cap disposed on the bottom end of the filter element, and a top cap disposed on the top end of the filter element. The top cap includes a disc which is parallel to and spaced a predetermined distance above the top end of the filter element, a cylindrical side wall depending from the disc in a direction of the filter element, an inlet extending from the disc in a direction of the filter head, such that the inlet mates with the filter head, and an outlet which is at least partially disposed within the inlet.

### BACKGROUND

The present invention relates to a water filtration assembly with a filter cartridge, and more particularly to an assembly including a filter head and a complementary filter sump which houses a replaceable disposable cartridge and features an improved keyed relationship with the filter head.

Conventional drinking water filter assemblies include filter cartridges which house a filter media, such as activated carbon granules, activated carbon blocks, membrane, resin, minerals or other known media, and a corresponding filter head designed to releasably and sealingly accommodate the filter cartridge and to couple the cartridge to an existing fluid flow line. It is common for filter cartridges to include input and output flow paths with openings at or near an upper end of the cartridge, also referred to as the filter cartridge closure. The flow paths communicate with the internal filter media, so that water flowing through the media in the cartridge is thus treated by removing unwanted substances, particles and properties, and then flows to the output opening, also known as the filter outlet.

Another feature of conventional water filter systems, is that since the cartridge needs periodic replacement, a mechanism is needed to prevent leakage while the spent cartridge is withdrawn, and a replacement installed. Often, such systems are mounted in a cabinet below the kitchen sink in a residence. Accordingly, spillage in the cabinet should be avoided. Many conventional filter cartridges have internal shutoff valves, which are manually operated or automatically activated with the disconnection of the cartridge. However, a recurring problem of such systems is the deterioration of seals in the system, which cause irritating leaks over time as the system ages.

A requirement for conventional water filter systems of this type, is accurate alignment of the filter cartridge into the head, so that the filter inlet and outlet flow paths in the cartridge are in proper alignment with similar passages in the filter head. Due to the common location of such systems in cabinets under the sink, or other hard to reach places, the positioning of the cartridge often becomes awkward for the user in these confined locations. As such, an upper portion of the cartridge, as well as the fixed filter head, are often fitted with guide or locating formations for facilitating proper engagement of the cartridge with the filter head.

A known approach to obtaining proper alignment between the filter cartridge and the head is to use a mating key and lock system, including mating respective formations on the head and cartridge. Conventional water filter systems are known to have key and lock features which are easily broken or disabled by the user.

Another design objective relates to the fact that conventional water filter cartridges are made of plastic housings that form the connection ports and also enclose the filter media. Upon exhaustion of the filter media, the entire cartridge is disposed of. There is a growing concern for reducing the amount of waste material, particularly plastic, that is sent to the landfill.

Thus, there exists a need of an improved water filtration assembly which addresses the design criteria discussed above.

### SUMMARY

The above-listed need is met or exceeded by the present water filtration assembly. Featured in the present water filtration assembly is a replaceable filter cartridge element disposed within a filter sump which engages with a filter head connected to an existing water line. The filter sump includes a sump body and an interlocking sump cap which house the replaceable filter cartridge, thereby reducing the waste generated by the present water filtration assembly. Additionally, the sump cap includes a central opening configured for receiving an inlet of the filter cartridge that extends above a top surface of the sump cap. The replaceable filter cartridge preferably mates directly with the filter head.

The filter cartridge includes a filter element with top and bottom filter caps which are preferably attached to the filter element with an adhesive. Preferably, the filter top cap and the sump cap include radially extending ramps which simultaneously engage with corresponding keys in the filter head. Specifically, rotation of the filter sump, which houses the filter cartridge, relative to the filter head causes the ramps to lock into place within the keys of the filter head.

Additionally, the filter top cap preferably includes locating tabs that are seated within corresponding recesses in an upper surface of the sump body. These locating tabs improve alignment between the radially extending ramps of the filter top cap and the radially extending ramps of the sump cap. In particular, the locating tabs help reduce the likelihood of the filter cartridge rotating relative to the sump cap, which would cause misalignment between the radially extending ramps of the filter top cap and the radially extending ramps on the sump cap.

In a preferred embodiment, the filter head includes a check valve downstream of the water inlet, which is engaged by the top cap of the filter cartridge. When the filter sump, which includes the filter cartridge, is mated with the filter head, a corresponding structure on the filter top cap engages the check valve in the filter head, allowing water to flow into the filter cartridge. However, when the filter sump is removed from the filter head, the filter cartridge no longer engages the check valve, and the flow of water is stopped. The check valve is in a default closed position. Preferably, an outlet of the filter cartridge is at least partially disposed within the inlet of the filter top cap, and a vertical protrusion of the outlet engages the check valve of the filter head.

The filter top cap includes a cylindrical side wall which extends toward the filter element, and a strainer, which has a tube and an annular flange extending from the strainer tube. The annular flange of the strainer preferably snap fits within a recess in the cylindrical side wall, and the annular flange of the strainer, with the filter top cap, form a cavity which receives water from the filter cartridge inlet. Seals, such as O-rings, are preferably used at the connection point between the strainer and the outlet of the filter cartridge.

Additionally, the sump body and the sump cap interlock with a combination of threading and a tab on the sump body which engages a corresponding indentation in the sump cap. The tab includes a spring that biases the tab away from the sump body, such that the tab engages a landing in the sump cap which increases in thickness radially around an outer periphery of the sump cap. After reaching the thickest part of the landing, the tab rests within an indentation in the landing due to the force of the spring. Engagement between the tab and the indentation preferably produces an audible response, indicating the that the cap is secured to the sump body. Pressing the tab and rotating the sump cap relative to the sump body allows disengagement of the sump cap with the sump body.

More specifically, a water filter assembly, is provided, including a filter cartridge housed within a filter sump which mates with a filter head that is in fluid communication with an existing water line, where the filter cartridge includes a filter element having a bottom end and a top end, a bottom cap disposed on the bottom end of the filter element, and a top cap disposed on the top end of the filter element. The top cap includes a disc which is parallel to and spaced a predetermined distance above the top end of the filter element, a cylindrical side wall depending from the disc in a direction of the filter element, an inlet extending from the disc in a direction of the filter head, such that the inlet mates with the filter head, and an outlet which is at least partially disposed within the inlet.

In a preferred embodiment, the filter cartridge includes a strainer within the top cap which has a tube having a first end and a second end, and an annular flange extending from the tube, such that the annular flange is snap fit into a recess within the cylindrical side wall, and the first end of the strainer mates with the outlet of the top cap. Preferably, the strainer and the top cap form a water inlet cavity which receives water from the filter head. Preferably still, the cylindrical side wall has at least one opening, and the water from the filter head flows through the at least one opening in the cylindrical side wall and toward the filter element.

In another preferred embodiment, the top cap includes a pair of locating tabs which extend beyond the cylindrical side wall, such that the locating tabs engage recesses in the filter sump. Preferably, the filter sump has a sump cap which interlocks with a sump body, and the sump cap includes two ramps which mate with keys on the filter head. Preferably still, the top cap includes two ramps which extend radially from the inlet of the top cap, the ramps of the top cap aligning with the ramps on the sump cap, such that the ramps of the top cap interlock with a pair of L-shaped keys of the filter head.

In yet another preferred embodiment, the sump cap and the sump body of the filter sump each include mating threading, the sump cap includes a landing proximate to a bottom edge of the sump cap which increases in thickness toward a center of the sump cap around an outer periphery of the sump cap until reaching a thickest portion which includes an indentation, and the sump body includes a tab which engages the landing of the sump cap, such that upon rotation of the sump cap relative to the sump body, the tab is pressed against the landing by a spring until the tab is housed within the indentation. Preferably, the sump cap engages a top surface of the locating tabs of the top cap.

In still another preferred embodiment, the inlet has a first portion with a first diameter and a second portion with a second diameter, such that the second portion is beneath the first portion and the second diameter is larger than the first diameter. The first portion is preferably received by the filter head and the second portion includes the two ramps.

In another preferred embodiment, the first end of the strainer has at least one seal between an exterior surface of the first end and an inner surface of the outlet of the filter cartridge, and an exterior surface of the inlet has at least one seal between the inlet and the filter head. Preferably, the outlet includes a vertical protrusion within the inlet which engages a check valve of the filter head.

A second embodiment of the present disclosure includes a filter sump assembly which mates with a filter head that is in fluid communication with an existing water line, where the filter sump assembly includes a sump body, a sump cap which interlocks with the sump body, and a filter cartridge housed within the sump body. The filter cartridge has a filter element with a bottom end and a top end, a bottom cap disposed at the bottom end of the filter element, and a top cap disposed at the top end of the filter element, where the top cap includes a disc which is parallel to and spaced a predetermined distance above the top end of the filter element, a cylindrical side wall depending from the disc in a direction of the filter element, an inlet extending from the disc in a direction of the filter head, such that the inlet mates with the filter head, and an outlet which is at least partially disposed within the inlet.

### BRIEF DESCRIPTION OF THE DRAWINGS

FIG. 1 is a front perspective view the present water filtration assembly;

FIG. 2 is an exploded perspective view of the water filtration assembly of FIG. 1;

FIG. 3 is a front perspective, vertical cross-section view of a filter sump with a filter cartridge of the water filtration assembly of FIG. 1;

FIG. 4 is an enlarged cross-section view of a bottom portion of the filter sump with the filter cartridge of FIG. 3;

FIG. 5 is an enlarged cross-section view of a top portion of the filter sump with the filter cartridge of FIG. 3;

FIG. 6 is an enlarged cross-section view of a top portion of the filter cartridge of FIG. 3;

FIG. 7 is a fragmentary top perspective view of the filter cartridge of FIG. 3;

FIG. 8 is a fragmentary top perspective view of the filter sump with the filter cartridge of FIG. 3;

FIG. 9 is an exploded perspective view of a filter sump cap and a filter sump body of the filter sump with the filter cartridge of FIG. 3;

FIG. 10 is a bottom perspective view of the filter sump cap of FIG. 9;

FIG. 11 is a bottom plan view of the filter sump cap engaged with a tab of the filter sump body of FIG. 9 in a first position;

FIG. 12 is a bottom plan view of the filter sump cap engaged with the tab of the filter sump body of FIG. 9 in a second position;

FIG. 13 is a bottom plan view of the filter sump cap engaged with the tab of the filter sump body of FIG. 9 in a third position;

FIG. 14 is a bottom plan view of the filter sump cap engaged with the tab of the filter sump body of FIG. 9 in a fourth, interlocked locked position;

FIG. 15 is an enlarged cross section view of the tab and a compression spring of the filter sump body of FIG. 9 when the sump body tab is engaging an indentation in the filter sump cap;

FIG. 16 is an enlarged cross section view of the sump body tab and the compression spring of the filter sump body of FIG. 9 when the tab is compressing the compression spring;

FIG. 17 is a bottom perspective view of a filter head of the filter assembly of FIG. 1;

FIG. 18 is a cross section view of the filter head of FIG. 17 taken along the line 18-18 and in the direction generally indicated;

FIG. 19 is a cross section view of the filter assembly of FIG. 1 when the filter sump is disengaged with the filter head; and

FIG. 20 is a cross section view of the filter assembly of FIG. 1 when the filter sump is engaged with the filter head.

### DETAILED DESCRIPTION

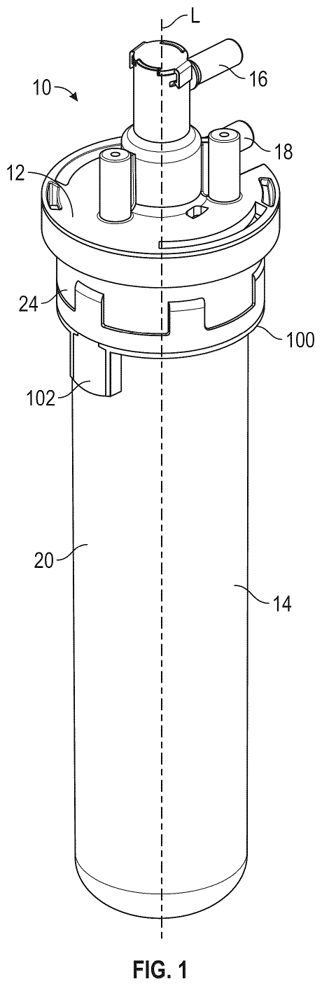

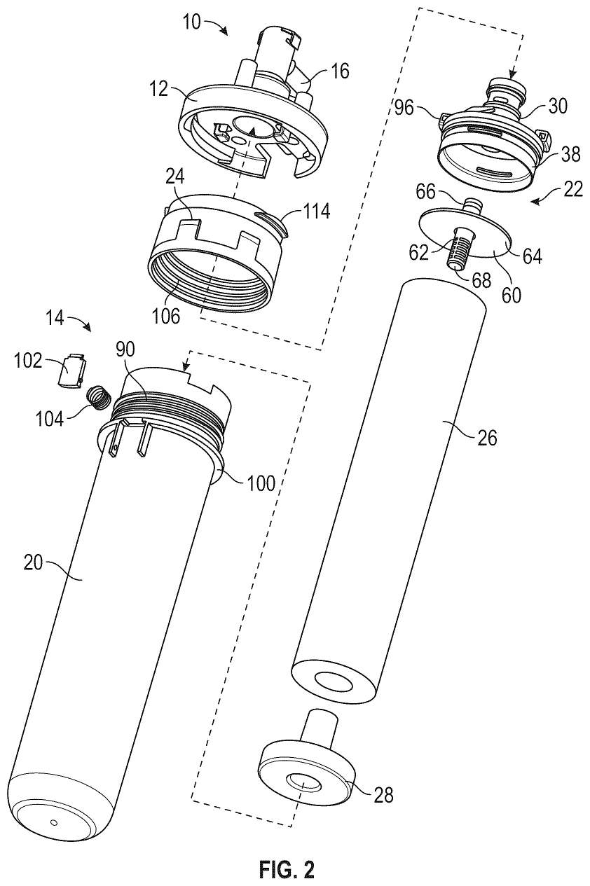

Referring now to FIGS. 1 and 2, in which the components are shown schematically and not to scale, the present water filtration assembly is generally designated 10, and includes a filter head 12 and a filter sump 14. An axis L is defined along a longitudinal extent of the water filtration assembly 10. The filter head 12, which is preferably made of molded plastic, is constructed and arranged for connection to an existing water line (not shown), and includes an inlet 16 and an outlet 18, each of which preferably extend perpendicularly from the longitudinal axis L. Preferably, the filter inlet 16 is disposed a greater distance from the filter sump 14 compared to the filter outlet 18. However, the location of the filter inlet 16 and the filter outlet 18 may be changed or reversed to suit the application and the internal configuration of the sump components described below.

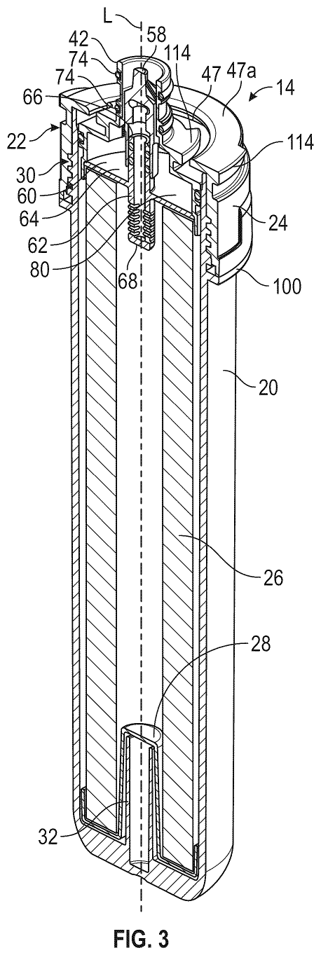

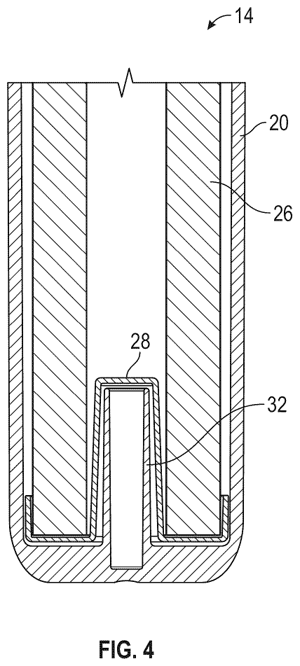

Referring now to FIGS. 2-6, the filter sump 14 includes a sump body 20 which houses a replaceable filter cartridge 22 and a sump cap 24 removably secured to the sump body. The filter cartridge 22 includes a filter element 26, preferably a carbon block, with a bottom cap 28 and a top cap 30, each of which are preferably attached to the filter element with an adhesive. The sump body 20 preferably includes a locating cylinder 32 (FIGS. 3 and 4) which extends from a bottom of the sump body and mates with a complementary recess in the bottom cap 28. Preferably, the locating cylinder 32 is centrally located within the sump body 20, and extends along the longitudinal axis L. The locating cylinder 32 enhances alignment of the filter cartridge 22 within the filter sump 14.

The top cap 30 includes a disc 34 which is parallel to and spaced a distance above a top end 36 of the filter element 26. A cylindrical side wall 38 depends from the disc 34 in a direction of the filter element 26, and preferably includes an annular recess 40 within the cylindrical side wall.

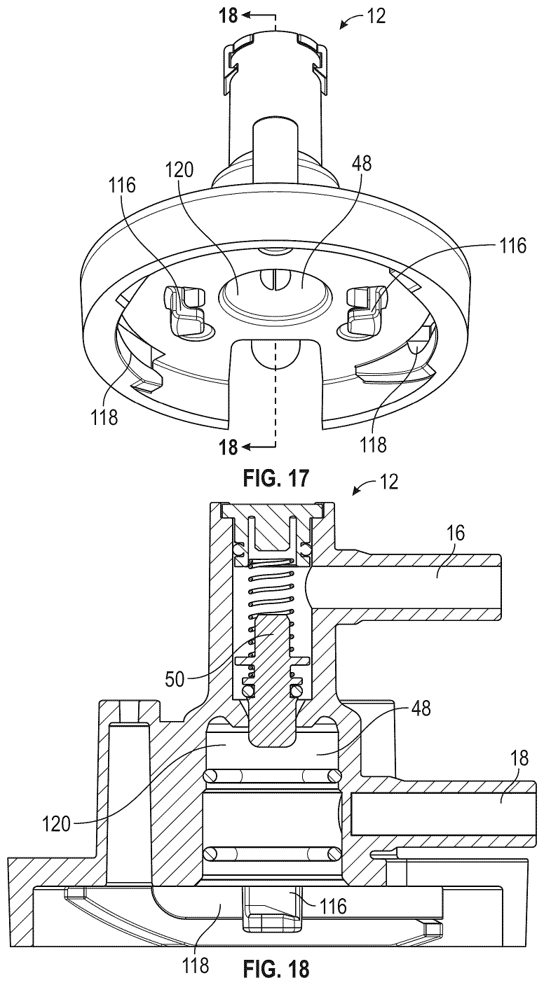

A filter cartridge inlet 42 extends from the disc 34 toward the filter head 12 in a direction opposite to the cylindrical side wall 36. In a preferred embodiment, the filter cartridge inlet 42 includes two cylindrical portions, namely a first portion 44 which has a first diameter and a second portion 46 which has a second diameter larger than the first diameter. Preferably, only the first portion 44 of the filter cartridge inlet 42 mates with a port 48 (FIGS. 17, 18) in the filter head 14.

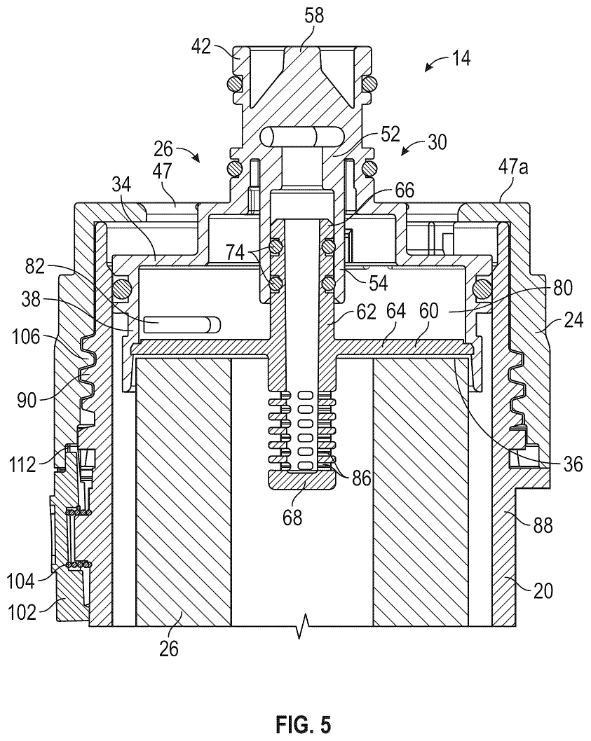

Additionally, the sump cap 24 includes an opening 47, through which the filter cartridge inlet 42 extends. Preferably, only the first portion 44 of the filter cartridge inlet 42 extends beyond the opening 47, and a top surface 47a of the opening is flush with a top surface 46a of the second portion 46 (FIG. 5).

Referring now to FIGS. 5, 6, and 18-20, in a preferred embodiment, a spring-biased check valve 50 is located within the filter head port 48, such that the check valve is in a default closed position and is located downstream of the filter head inlet 16 and upstream of the filter cartridge inlet 42. Moreover, an outlet 52 of the filter cartridge 22 is at least partially disposed within the filter cartridge inlet 42. The outlet 42 includes a preferably cylindrical body 54, and a ceiling 56 which connects to, or is integral with, the body of the outlet. A vertical protrusion 58 extends from the ceiling 56 and engages the check valve 50 and forces it to an open position by overcoming the biasing force of the spring. Accordingly, when the filter cartridge 22 engages with the filter head 12, and opens the check valve 50, water begins to flow from the inlet 16 of the filter head and through the filter cartridge. When the filter cartridge 22 is not engaged with the filter head 12, the check valve 50 is biased to the closed position and thus prevents water from flowing through the filter head inlet 16.

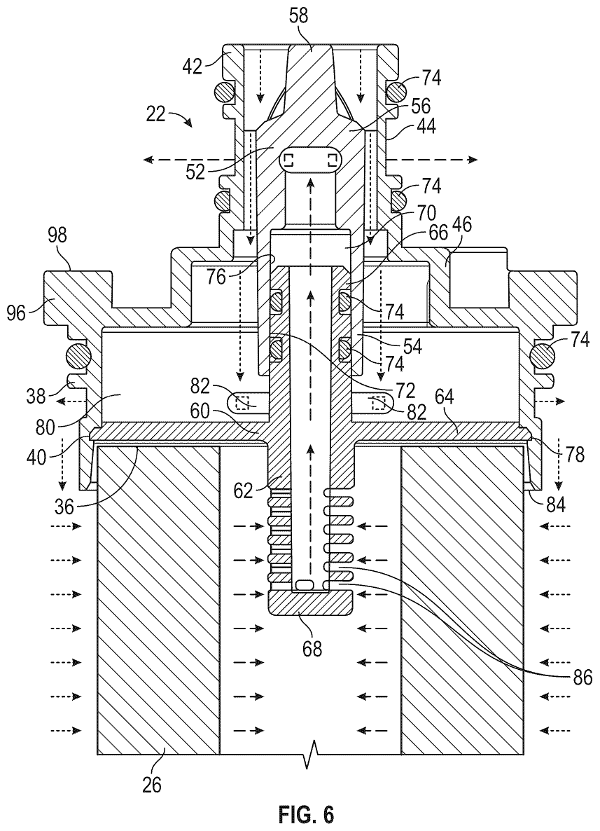

Returning to FIGS. 5 and 6, the filter cartridge 22 preferably includes a strainer 60 with a tube 62 and a radially extending flange 64, which is preferably disposed approximately halfway between a first end 66 and a second end 68 of the tube. The first end 66 of the tube 62 is received by a port 70 within the filter cartridge outlet 48, and the port within the filter cartridge outlet preferably extends below the filter cartridge inlet 42. An exterior surface 72 of the first end 66 includes at least one seal 74, such as an O-ring, disposed between the exterior surface of the first end and an interior surface 76 of the port 70. The at least one seal 74 helps reduce cross contamination between the filtered outlet water and the unfiltered inlet water.

An outer edge 78 of the annular flange 64 of the strainer 60 snap fits within the recess 40 in the cylindrical side wall 38, thereby forming a cavity 80 connected to the filter cartridge inlet 42, such that water from the filter cartridge inlet travels through the cavity and exits through an opening 82 in the cylindrical side wall of the filter top cap 30.

The water flow path through the filter cartridge 22 is shown in FIG. 6 and described in greater detail below. Specifically, water from the filter head inlet 16 travels through the filter cartridge inlet 42 and around the filter cartridge outlet 48 to the cavity 80. Then, the water travels through the opening 82 and below a bottom 84 of the cylindrical side wall 38 before passing through the filter element 26 and slots 86 in the second end 68 of the strainer tube 62. Finally, the filtered water travels through both the first end 66 of the strainer 60 and the filter cartridge outlet 48, before traveling through the filter head outlet 18.

The slots 86 provided in the second end 68 prevent particles from the filter element 26 from flowing through the outlet in the first end 66 of the strainer 60. Specifically, the slots 86 are dimensioned to allow filtered water to pass through, while a height of the slots is smaller than the size of the filter media within the filter element 26, so that if the filter media is blocked from entering the tube 62. Thus, the slots 86 prevent the filter media from passing through the strainer 60 with the filtered water.

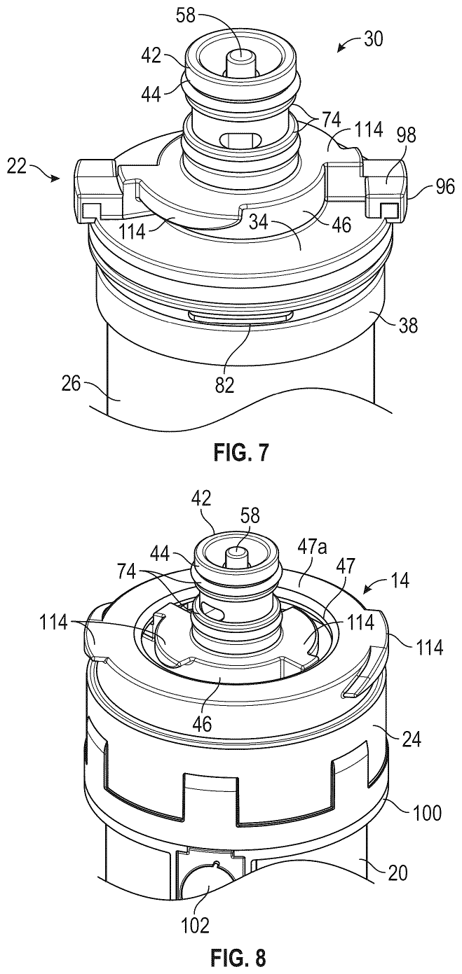

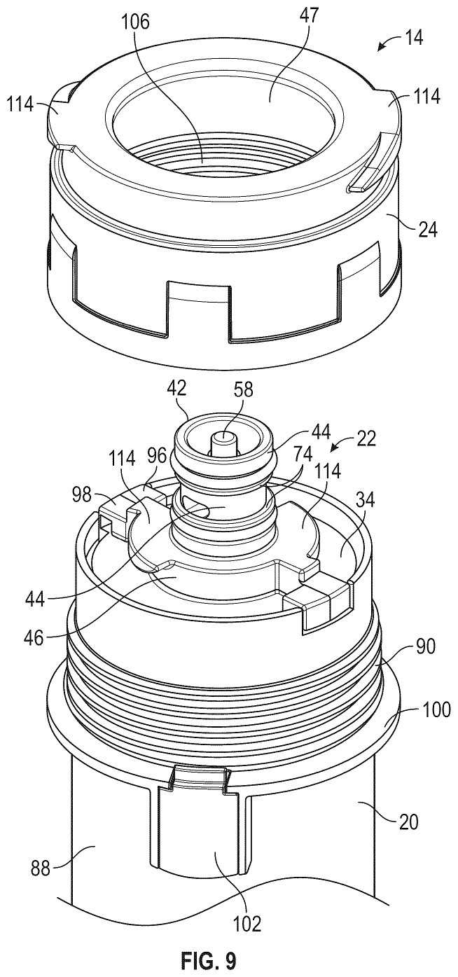

Referring to FIGS. 2 and 5-8, an outer surface 88 of the filter sump body 20 has male threading 90 which is spaced a predetermined distance below an upper edge 92 of the sump body. Preferably, the sump body 20 includes at least two recesses 94 in the upper edge which receive corresponding locating tabs 96 of the filter top cap 30, thereby helping reduce rotation of the filter top cap in relation to the filter sump body 20, especially as the user removes the sump 14 from the filter head 12. Preferably, a top surface 98 of the locating tabs 96 is flush with the upper edge 86. Beneath the male threading 90 of the filter sump body 20 is a ledge 100 which extends outwardly from the filter sump body and a tab 102 which is biased by a spring 104 away from the filter sump body.

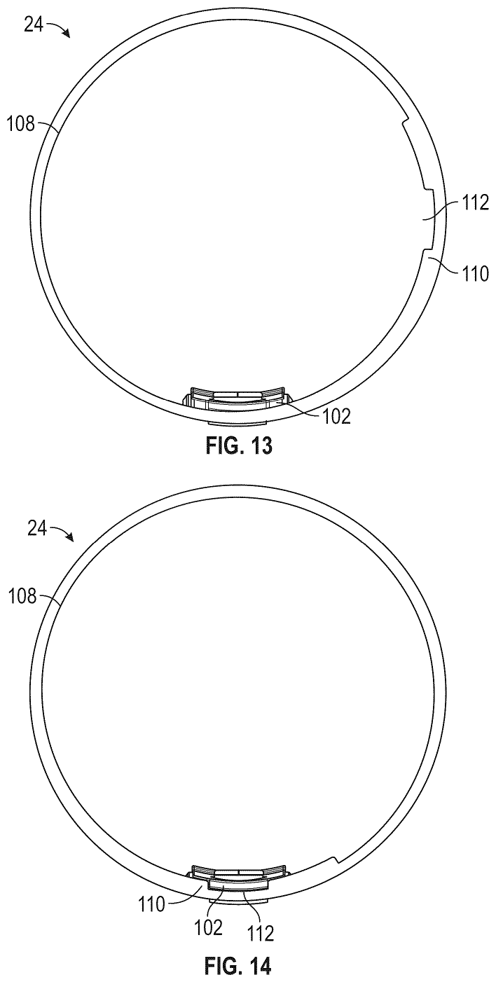

The sump cap 24 includes corresponding female threading 106 which mates with the male threading 90 of the filter sump body 20. Referring to FIGS. 13-17, beneath the female threading 106, the sump cap 24 includes a landing 108 which gradually increases in thickness in a radial direction toward a center of the sump cap as the landing proceeds in a peripheral direction around the sump cap. A thickest portion 110 of the landing includes an indentation 112 which receives the tab 102.

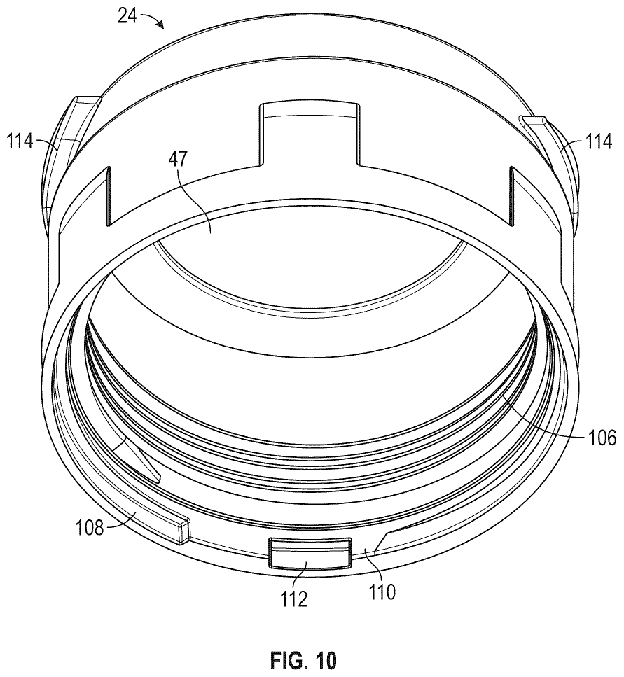

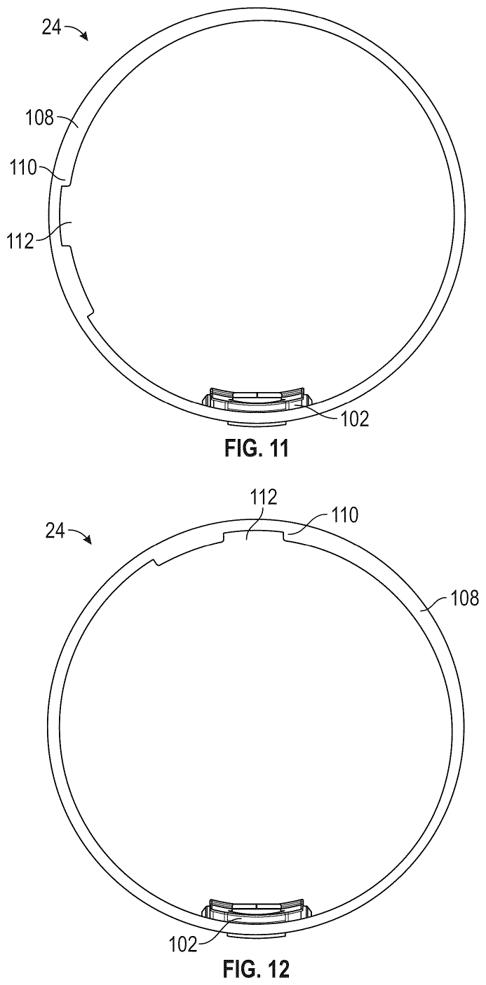

In relation to FIGS. 8 and 13-19, the method for interlocking the sump cap 24 and the sump body 20 is described below. As the female threading 106 and the male threading 90 are initially threaded, the sump cap 24 is rotated clockwise relative to the sump body 20. After a specified number of rotations of the sump cap 24, the tab 102 engages the landing 108 and is pressed against the landing by the spring 104 as the sump cap is rotated through the final rotation to fully engage the sump cap and the sump body 20. FIGS. 11-15 illustrate the final rotation of the sump cap 24 in relation to sump body.

During the final rotation, the tab 102 engages the landing 108 near its thinnest point (FIG. 11) and the sump cap 24 is rotated clockwise with respect to the sump body 20, such that the tab gradually compresses the spring 104. As the sump cap 24 continues to rotate (FIGS. 12 and 13), the spring 104 is further compressed until the tab 102 reaches the thickest portion 110 of the landing 106, after which the tab reaches the indentation 112 (FIG. 14) and is pressed into the indentation by the spring. Preferably, this results in an audible sound which confirms that the tab 102 has reached the indentation 112.

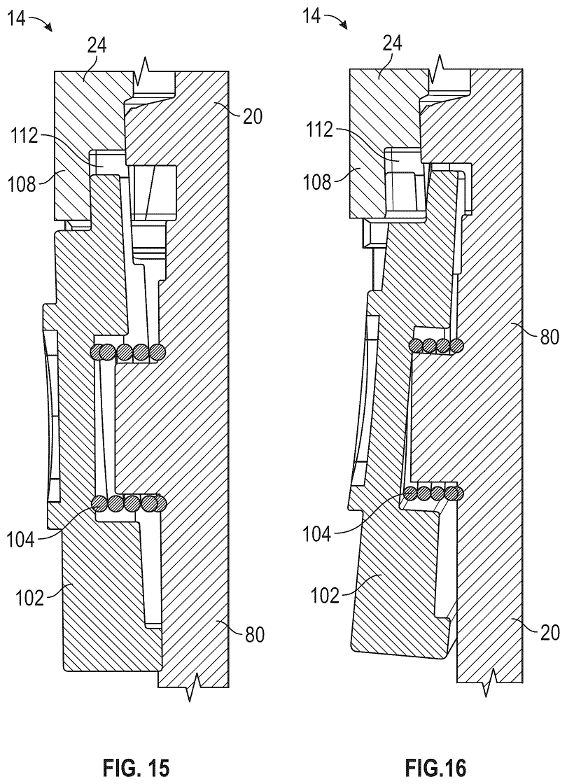

FIG. 15 demonstrates the tab 102 compressing the spring 104 when the tab has reached the thickest portion 110, while FIG. 16 demonstrates the tab being housed within the indentation 112. When the user replaces the filter cartridge 22, the sump cap 24 is removed from the sump body 20 by pressing the tab 102 so that the tab clears the thickest portion 110 of the landing 108 and rotating the sump cap 24 counterclockwise relative to the sump body 20.

Referring to FIGS. 17-20, the assembled filter sump 14 mates with the filter head 12 to form the water filter assembly 10. Specifically, the sump cap 24 and the filter top cap 30 include ramps 114 which engage with corresponding keys of the filter head 14. In a preferred embodiment, the filter top cap 30 includes two radially, outwardly extending ramps 114 which extend away from the center of the top cap, and which engage with corresponding L-shaped keys 116 on the filter head 12. Additionally, an exterior surface of the filter sump cap 24 preferably includes two of the radially, outwardly extending ramps 114 which engage corresponding keys 118 along an inner circumferential surface 120 of the filter head 12. In a preferred embodiment, the ramps 114 on the filter top cap 30 are disposed on the second portion 46 of the filter cartridge inlet 48.

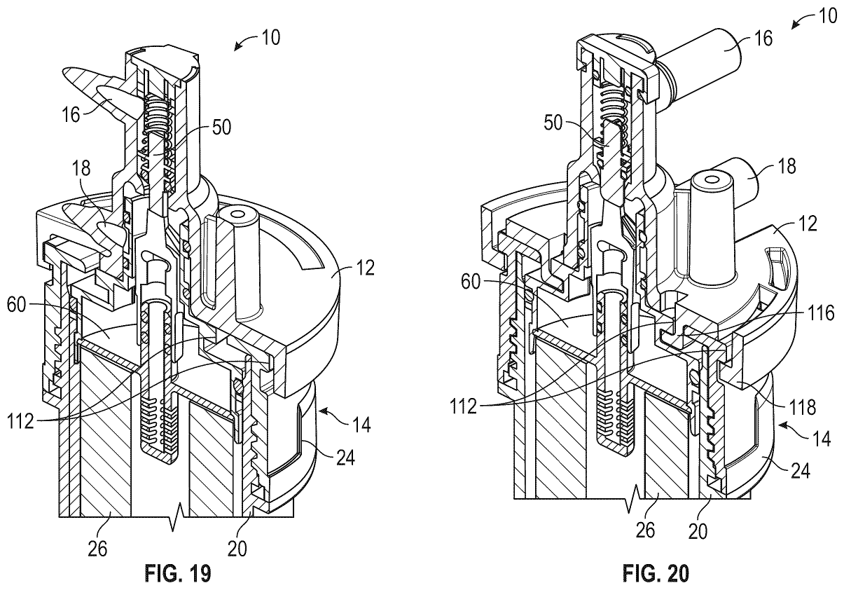

FIG. 19 illustrates a state in which the filter sump 14 is disengaged with the filter head 12, and the ramps 114 of the filter sump cap 24 and the filter top cap 30 are aligned but not interlocked with the corresponding keys 116, 118 of the filter head. In this state, the vertical protrusion 58 activates the check valve 50 of the filter head 14, allowing water to flow to the filter sump 14. When the filter sump 14 is rotated, as illustrated in FIG. 20, the ramps 114 engage with the corresponding keys 116, 118, and the filter sump mates with the filter head 12.

While a particular embodiment of the present water filtration assembly has been described herein, it will be appreciated by those skilled in the art that changes and modifications may be made thereto without departing from the invention in its broader aspects and as set forth in the following claims.

1. A filter cartridge housed within a filter sump which mates with a filter head that is in fluid communication with an existing water line, said filter cartridge comprising:
a filter element having a bottom end and a top end;
a bottom cap disposed at said bottom end of said filter element; and
a top cap disposed at said top end of said filter element, said top cap comprising:
a disc which is parallel to and spaced a predetermined distance above said top end of said filter element;
a cylindrical side wall depending from said disc in a direction of said filter element;
an inlet extending from said disc in a direction of the filter head, such that said inlet mates with the filter head; and
an outlet which is at least partially disposed within said inlet.

2. The filter cartridge of claim 1, further comprising a strainer within said top cap, said strainer comprising:
a tube having a first end and a second end; and
an annular flange extending from said tube;
wherein said annular flange is snap fit into a recess within said cylindrical side wall, and wherein said first end of said strainer mates with a port within said outlet of said top cap.

3. The filter cartridge of claim 2, wherein said strainer and said top cap form a water inlet cavity which receives water from the filter head.

4. The filter cartridge of claim 3, wherein said cylindrical side wall has at least one opening, and wherein the water from the filter head flows through said at least one opening in said cylindrical side wall and toward said filter element.

5. The filter cartridge of claim 1, wherein said top cap includes a pair of locating tabs which extend beyond said cylindrical side wall, wherein said locating tabs engage recesses in the filter sump.

6. The filter cartridge of claim 5, wherein the filter sump further comprises a sump cap which interlocks with a sump body, and the sump cap includes two ramps which mate with keys on the filter head, said top cap further comprising:
two ramps which extend radially from said inlet of said top cap, said ramps of said top cap aligning with the ramps of the sump cap, wherein said ramps of said top cap interlock with a pair of L-shaped keys of the filter head.

7. The filter cartridge of claim 6, wherein:
the sump cap and the sump body of the filter sump each include mating threading;
the sump cap includes a landing proximate to a bottom edge of the sump cap which increases in thickness toward a center of the sump cap around an outer periphery of the sump cap until reaching a thickest portion which includes an indentation; and
the sump body includes a tab which engages the landing of the sump cap, such that upon rotation of the sump cap relative to the sump body, the tab is pressed against the landing by a spring until the tab is housed within the indentation;
wherein the sump cap engages a top surface of said locating tabs of said top cap.

8. The filter cartridge of claim 6, wherein said inlet comprises a first portion having a first diameter and a second portion having a second diameter, wherein said second portion is beneath said first portion and said second diameter is larger than said first diameter, said first portion being received by the filter head and said second portion comprising said ramps of said top cap.

9. The filter cartridge of claim 1, wherein said first end of said strainer comprises at least one seal between an exterior surface of said first end and an inner surface of said outlet of said filter cartridge, and wherein an exterior surface of said inlet comprises at least one seal between said inlet and the filter head.

10. The filter cartridge of claim 1, wherein said outlet further comprises a vertical protrusion within said inlet which engages a check valve of the filter head.

11. A filter sump assembly which mates with a filter head that is in fluid communication with an existing water line, said filter sump assembly comprising:
a sump body;
a sump cap which interlocks with said sump body;
a filter cartridge housed within said sump body, said filter cartridge comprising:
a filter element having a bottom end and a top end;
a bottom cap disposed at said bottom end of said filter element; and
a top cap disposed at said top end of said filter element, said top cap comprising:
a disc which is parallel to and spaced a predetermined distance above said top end of said filter element;
a cylindrical side wall depending from said disc in a direction of said filter element;
an inlet extending from said disc in a direction of the filter head, such that said inlet mates with the filter head; and
an outlet which is at least partially disposed within said inlet.

12. The filter sump assembly of claim 11, further comprising a strainer within said top cap, said strainer comprising:
a tube having a first end and a second end; and
an annular flange extending from said tube;
wherein said annular flange is snap fit into a recess within said cylindrical side wall, and wherein said first end of said strainer mates with said outlet of said top cap.

13. The filter sump assembly of claim 12, wherein said strainer and said top cap form a water inlet cavity which receives water from the filter head.

14. The filter sump assembly of claim 13, wherein said cylindrical side wall comprises at least one opening, and wherein the inlet water from the filter head flows through said at least one opening in said cylindrical side wall and toward said filter element.

15. The filter sump assembly of claim 11, wherein said top cap includes a pair of locating tabs which extend beyond said cylindrical side wall, wherein said locating tabs engage recesses in said sump body.

16. The filter sump assembly of claim 15, wherein said sump cap includes two ramps which mate with keys on the filter head, and wherein said top cap includes two ramps which extend radially from said inlet, said ramps of said top cap aligning with said ramps of said sump cap, wherein said ramps of said top cap interlock with a pair of L-shaped keys of the filter head.

17. The filter sump assembly of claim 16, wherein:
said sump cap and said sump body each include mating threading;
said sump cap includes a landing proximate to a bottom edge of said sump cap which increases in thickness toward a center of said sump cap around an outer periphery of said sump cap until reaching a thickest portion which includes an indentation;
said sump body includes a tab which engages said landing, such that upon rotation of said sump cap relative to said sump body, said tab is pressed against said landing by a spring until said tab is housed within said indentation; and
said sump cap engages a top surface of said locating tabs of said filter cap.

18. The filter sump assembly of claim 16, wherein said inlet of said top cap comprises a first portion having a first diameter and a second portion having a second diameter, wherein said second portion is beneath said first portion and said second diameter is larger than said first diameter, said first portion being received by the filter head and said second portion comprising said ramps of said top cap.

19. The filter sump assembly of claim 11, wherein said first end of said strainer comprises at least one seal between an exterior surface of said first end and an inner surface of said outlet of said filter cartridge, and wherein an exterior surface of said inlet comprises at least one seal between said inlet and the filter head.

20. The filter sump assembly of claim 11, wherein said outlet further comprises a vertical protrusion within said inlet which engages with a check valve of the filter head.
